(19) United States
(12) Patent Application Publication
(10) Pub. No.: US 2019/0066233 A1
(43) Pub. Date: Feb. 28, 2019

(54) METHOD AND SYSTEM FOR COLLABORATIVE CONTENT RELATION MANAGEMENT

(71) Applicant: Amin Almassian, Scotts Valley, CA (US)

(72) Inventor: Amin Almassian, Scotts Valley, CA (US)

(21) Appl. No.: 16/118,489

(22) Filed: Aug. 31, 2018

Related U.S. Application Data
(60) Provisional application No. 62/552,941, filed on Aug. 31, 2017.

(51) Int. Cl. G06Q 50/00; G06N 99/00

(52) U.S. Cl. CPC G06Q 50/01; G06N 99/005

(57) ABSTRACT

A method comprising; receiving a first content submitted to a content collection, analyzing the first content in relation to at least one existing content, processing the relation between the first content and the at least one existing content and determining if a relationship exists between the contents, creating a set of relation data between the new content and the at least one existing content, wherein it is determined that a relationship exists between the contents, calculating a score value between the association of the first content and each of the at least one existing contents which a set of relation data was created between the contents, aggregating a data set of the content collection data; adjusting accessibility of the aggregated data set, processing a request for a subset data set of the data set, and formatting the requested subset data set and presenting in a readable format.

### CROSS-REFERENCE TO RELATED APPLICATIONS

This application claims the benefit of priority under 35 USC 120 of U.S. provisional patent application 62/552,941 filed on Aug. 31, 2017. The disclosure of the prior applications is considered part of (and is incorporated by reference in) the disclosure of this application.

### FIELD OF THE INVENTION

The invention relates to establishing and managing the relations between contents and more specifically to a method, computer program and computer system to collaboratively establishing and managing informative relations between contents.

Every day, millions of contents including text, audio, video, image, web links and much more are shared in the Internet and online social networks. Moreover, users of the social networks make billions of content views each day. Contents are published with various intentions including promoting a product or thought, sabotaging competitors of a company or product, conveying educational and informational information, and so on. On the one hand, not all the intentions are authentic and may not represent the reality. On the other hand, the volume of information in the todays' media is beyond ones' attention and time limits to be processed.

This makes it very difficult for the users to distinguish genuine contents from crafted ones that try to obscure the reality for the benefits of the author. We are becoming more vulnerable to the ever-existing problems of fake news and agenda settings. What is needed is a system and method that raises the awareness of the content consumers and help them in drawing clear, accurate, and significant conclusions in the midst of massive media information. It is an object of this invention to leverage the social intelligence and allow the users to collaboratively add valuable information to the contents thereby enhancing the reasoning capability and awareness of the content consumers.

Thus, it is important to have a system which is able to associate contents from various sources and build enough context around a content to assist users in distinguishing genuine content from fake content and, more importantly, in drawing judicious conclusions about the content.

### SUMMARY OF THE INVENTION

In a first embodiment, the present invention is a method for resolving terminated transactions, the method comprising; receiving, by one or more processors, a first content submitted to a content collection; analyzing, by one or more processors, the first content in relation to at least one existing content within the content collection; processing, by one or more processors, the relation between the first content and the at least one existing content and determining if a relationship exists between the contents; creating, by one or more processor, a set of relation data between the new content and the at least one existing content, wherein it is determined that a relationship exists between the contents; calculating, by one or more processors, a score value between the association of the first content and each of the at least one existing contents which a set of relation data was created between the contents; aggregating, by one or more processors, a data set of the at least one contents and the relations between the at least one contents within the content collection; adjusting, by one or more processors, accessibility of the aggregated data set based on the score value associated with each content and the content collection; processing, by one or more processors, a request for a data subset of the data set, wherein the data subset is associated with a predetermined set of parameters of the data set; and formatting, by one or more processors, the requested data subset to a readable format.

In a second embodiment, the present invention is a computer program product for resolving terminated transactions, the method comprising: one or more computer readable storage media and program instruction stored on the one or more computer readable storage media, the program instructions comprising: program instructions to receive relationship data between at least two contents within a content collection; program instructions to process the relationship data between the at least two contents and determining if a relationship already exists based on the relationship data, wherein a relationship does not exist; program instructions to create a relation between the at least two contents; program instructions to calculate a score value between the at least two contents; program instructions to aggregate a content collection data set; program instructions to adjust accessibility of the aggregated content collection data set; program instructions to process a request for a subset data set of the content collection data set; and program instructions to provide the requested subset data set.

In a third embodiment, the present invention is a computer system for protecting a resource, the computer program product comprising: one or more computer processors, one or more computer readable storage media, and program instructions stored on the one or more computer readable storage media for execution by, at least one of the one or more processors, the program instructions comprising: program instructions to receive a first content submitted to a content collection; program instructions to analyze, the first content in relation to at least one existing content within the content collection; program instructions to process, the relation between the first content and the at least one existing content and determining if a relationship exists between the contents; program instructions to create a set of relation data between the new content and the at least one existing content, wherein it is determined that a relationship exists between the contents; program instructions to calculate a score value between the association of the first content and each of the at least one existing contents which a set of relation data was created between the contents; program instructions to aggregate a data set of the content collection data; program instructions to adjust the accessibility of the aggregated content collection data set; program instructions to process a request for a subset data set of the data set of the content collection; and program instructions to format the requested subset data set and presenting in a readable format.

### BRIEF DESCRIPTION OF THE DRAWINGS

FIG. 1 depicts a block diagram depicting of a relation, in accordance with one embodiment of the present invention.

FIG. 2 depicts a block diagram depicting of a relation graph, in accordance with one embodiment of the present invention.

FIG. 3 depicts a block diagram depicting of a computing environment, in accordance with one embodiment of the present invention.

FIG. 4 depicts a flowchart of the operation steps taken by the program associated with the relation manager and the relation playback device, in accordance with one embodiment of the present invention.

FIG. 5 depicts a block diagram of the internal and external components of the devices of FIG. 3.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

In the following discussion of illustrative embodiments, the terms “coupled to,” “are connected,” or “in communication with,” refer to, without limitation, any connection or coupling, either direct or indirect, between two or more elements whether physical, logical, electrical, or combinations thereof. As one skilled in the art will appreciate, inferred coupling (that is, where one element is coupled to another element by inference) includes direct and indirect coupling between two elements in the same manner as “coupled.” The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “based on,” as used in the claims and specification herein, is not exclusive and allows for being based on additional factors that may or may not be described. The terms “example”, “such as”, and “like”, as used in the claims and specification herein, shall be understood as an open group of embodiments that is described by way of example and shall not be construed as limitations on the scope of any inventions or what may be claimed, but rather as descriptions of features specific to particular embodiments of particular inventions. The term “collection” and “list” in the claims and specification herein, refer to a collection of information stored in some fashion.

I.e. is not merely a list data structure and may be implemented by variety of data structures including, but not limited to, trees, graphs, linked lists, hash tables, arrays, bloom filters and may store in one or plurality of storage devices. The term “user” shall be taken to include both human and non-human objects or entities that may interact with the disclosed method and/or system. Example of users may include, but are not limited to, a human, animals, other systems and methods, robots, hardware or software program products, machines, devices and apparatuses, and so on. The term “identifier” in the claims and specification herein, refer to any piece of information that can be used to locate another information inside or outside the disclosed method and/or system. For example, a content may be located by an integer identifier, Universally Unique Identifier (UUID), a Uniform Resource Identifier (URI) or other types of identifiers.

It is to be understood that the figures and descriptions of the invention have been simplified to illustrate elements that are relevant for a clear understanding of the invention while eliminating, for purposes of clarity, other elements. For example, details relating to the creation of a content or retrieval of a content by a content identifier on a processing circuit or system are not described herein. A content is any piece of information including, but not limited to, an image, video, audio, web page, blog post, social media post, news article, analog or digital signal information, location information, algorithm, program, software, or other known pieces of information or forms of data. The content is typically found on the internet, intranets, or created using a computing device. Similarly, the communication methods such as wired or wireless networking are not described herein. A discussion of these elements is not provided because they are well known in the art and because they do not facilitate a better understanding of the invention.

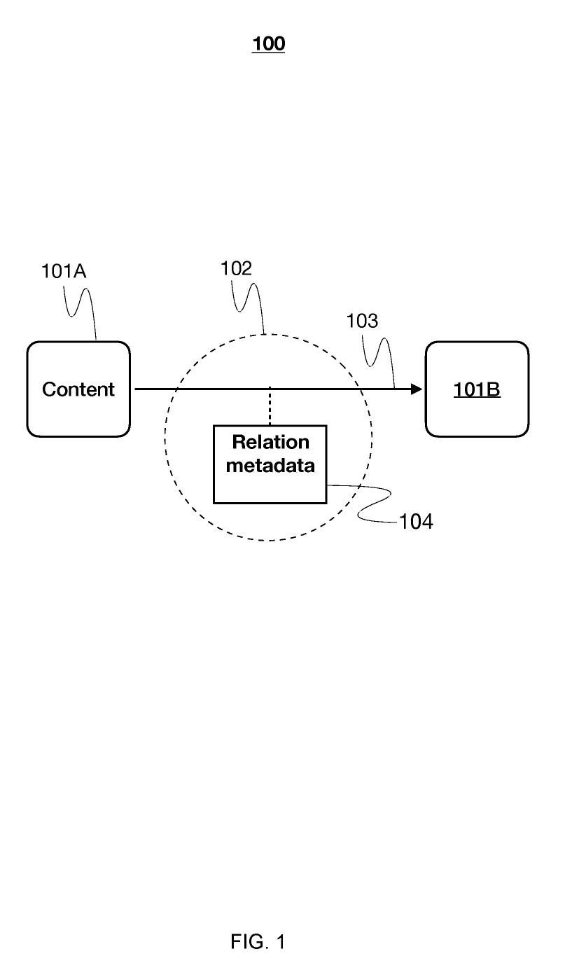

FIG. 1 depicts a block diagram depicting of the relation 100, in accordance with one embodiment of the present invention. A relation 102 may be a quantity of information comprising a representation of association 103 between two different contents 101A and 101B by means of two content identifiers and additional information about this association that is referred to as relation metadata 104 herein. Content 101B may be one or more contents.

The two associated contents 101A and 101B are referred to as source and destination contents herein. Relation metadata 104 may include additional information about the association 103 of the two contents 101A and 101B including, but not limited to, source and destination content identifiers, source and destination content-part identifiers, relation type, a weight score, a function by which the relation weight score may get changed, the time and location of creation and updates, information about the user(s) who create or update the relation, and comments. The relation association 103 and metadata 104 may be stored and/or represented in different forms including, but not limited to, one or more blocks of data per relation and/or one or more blocks of data per content. For example, the association between the content 101A to other contents 101B and the relation metadata 104 can be stored in a block of information with content identifiers and many other related content identifiers or they can be stored in a collection of pairs of content identifiers, each pair comprising content identifier and another identifier for a related content 101A or 101B and the pertaining metadata 104. A simplified relation-type may be one of, including, but not limited to the terms “support,” “reject,” “describe,” “summarize,” “reason,” “make fun of,”, etc. Comments can be of variety of forms such as text, video, voice, analog or digital signal information, or combinations thereof. A content may comprise including, but not limited to, text, image, video, voice, web page, blog post, social media post, news, analog or digital signal information, or a combination thereof. It may also include another content Identifier as a reference or another content. A relation 102 may be represented in different forms and by variety of data structures and can be stored on any storage medium including. For example, storage 503, memory 502, neural computation devices, cloud storages, quantum computing devices, block chain, and the like.

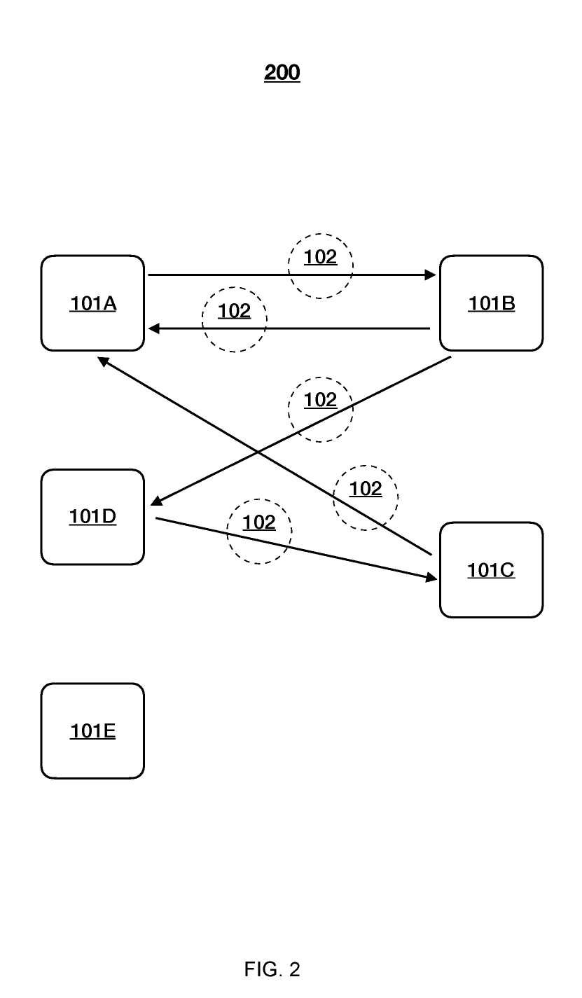

FIG. 2 depicts a block diagram depicting 200 of a relation graph, in accordance with one embodiment of the present invention. FIG. 2 is an illustrative conceptual diagram of a relation collection 200 which may be resulted by a plurality of contents 101A-E and their relations 102 and is shown as a graph comprising contents 101 as vertices and relations 102 as edges of the graph. It is shown how multiple contents 101 may be related to one another on various different relationship associations. In the depicted embodiment, content 101A is associated with content 101B and content 101C, while content 101D is associated with content 101B and content 101C, while content 101E is not associated with any of the other contents based on the metadata 104 or may be a new content added to the relations collection 200, which has not been processed yet. It shall be understood that the contents 101A-E are also in the relation collection 200 even though they may have no relation 102 associated with them. The relation collection 200 may be represented in different forms and by variety of data structures and their combinations including, but not limited to, trees, graphs, linked lists, hash tables, arrays, bloom filters, neural networks, and may store in one or a plurality of storage mediums. For example, storage 503, memory 502, neural computation devices, cloud storages, quantum computing devices, block chain, and the like.

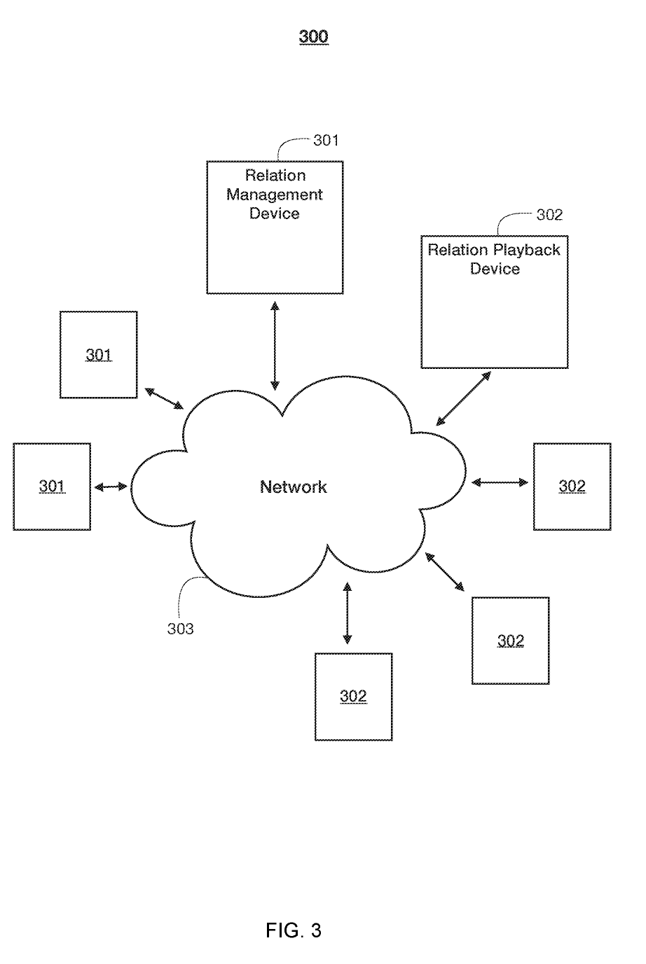

FIG. 3 depicts a block diagram 300 depicting of a computing environment, in accordance with one embodiment of the present invention. System 300 includes a plurality of relation playback devices 302 and one or a plurality of relation management devices 301 coupled to a network 303 as shown. System 300 may also include a plurality of devices that are a combination of both relation management devices 301 and relation playback devices 302. For example, a device may play the role of both relation management device 301 and relation playback device 302 together where the network 303 could also include a local network that is internal to the device. However, these devices are shown separately for brevity in discussing the illustrative embodiment. The relation management devices 301 and relation playback devices 302 can be any computing devices including server computers, virtual and cloud-based computing systems, cell phones, personal digital assistants, tablet computing devices, personal computers, personal storage devices, home media servers, wearable devices, virtual reality (VR) devices, augmented reality (AR) devices, Internet of Things (TOT) devices, etc.

Network 303 may be a local area network (LAN), a wide area network (WAN) such as the Internet, any combination thereof, or any combination of connections and protocols that can support communications between the management devices 301 and the playback devices 302. Network 303 may include wired, wireless, or fiber optic connections.

The relation playback device 302 can be used to create a content 101 or provide content identifier as a reference to a content 101 outside the disclosed system and share it with other users of the system 300. The content or the content identifier may be sent to the relation management device 301 in a request. In case of content identifier, the main content or a portion of the referenced content may be extracted and sent along with the content identifier. The relation management device 301 receives the request and stores the content and/or the identifier in a storage 503. The relation playback device 302 can show a content or a list of the contents that are shared with the user by communicating with the relation management device 301 and consulting with an accessibility list generated for the user. The relation playback device 302 may also allow the user to search for a content or relation 102 by entering some information including, but not limited to, a string, voice, and video in a user interface. To that end, the relation playback device 302 may send the entered information to the relation management device 301 and receives a subset of the found contents or relations 102 in response.

The relation playback device 302 enables the users to create a relation 102 between two contents via a user interface. To that end, the relation playback device 302 sends the relation metadata 104 to the relation management device 301. The relation management device 301 follows the process 400, in accordance with some embodiments of the invention, to accommodate for creation of the relation. The user may use the user interface provided by the relation playback device 302 to increase or decrease the weight score of an existing relation 102. The relation playback device 302 sends a data comprising the relation identifier and a weight change value to the relation management device 301 and the relation management device 301 changes the weight score of the relation 102 by following relevant steps described in the method 400.

The relation playback device 302 can show the detail of a content and the content's relations metadata 104 including, but not limited to, the statistics about the other contents that are related to a content with specific relation 102 types. Examples of the mentioned statistics may include, but are not limited to, the number of other contents, average/variance/deviation of the weight score for the relations 102 that relate the content to the other contents, and history of increase or decreases in the relation 102 weights categorized by relation 102 types.

The relation playback device 302 can also show detailed information about the relations 102 that relate a content to other contents with specific relation 102 types, including, but not limited to, the comments on a relation 102, the information about the users who contributed in creating or updating the relation 102, and the weight score changes made by the users.

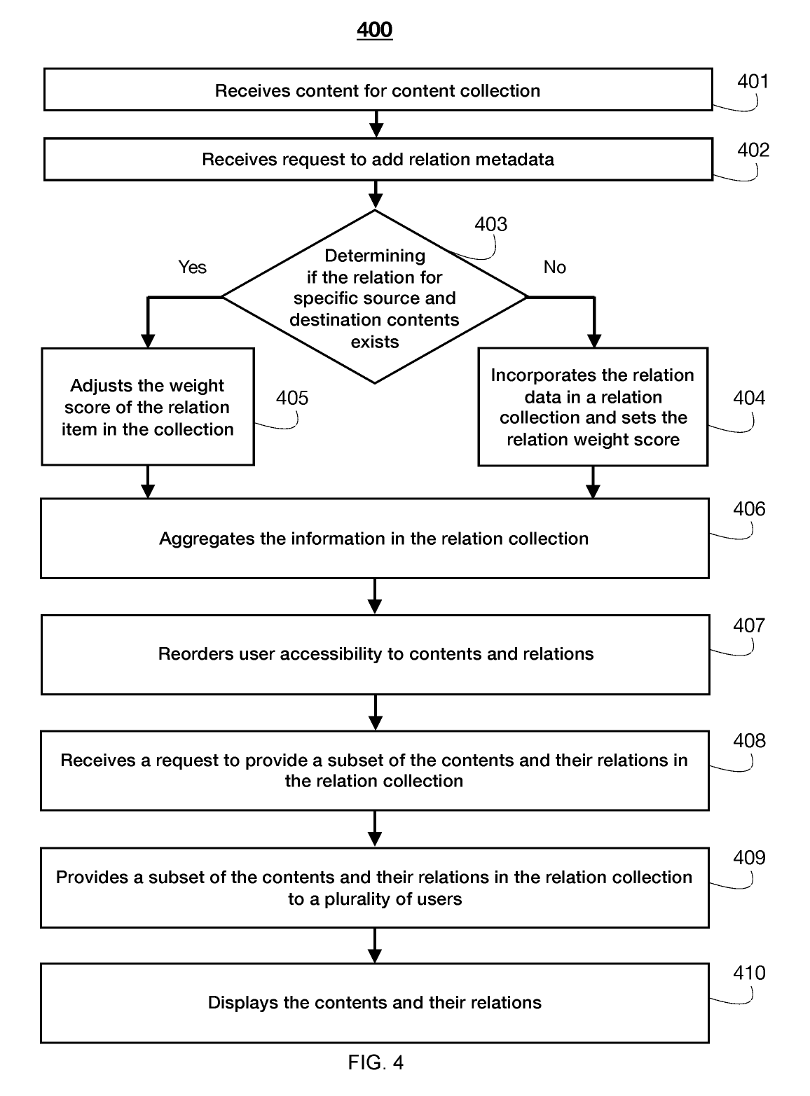

FIG. 4 depicts a flowchart 400 of the operation steps taken by the relation management device 301 and the relation playback device 302, in accordance with one embodiment of the present invention. The process diagram of the exemplary method depicts a collaborative management of relations 102 between a plurality of contents, in accordance with one embodiment of the invention. The depicted method begins with the relation management device 301 receiving relation metadata 104. In an additional embodiment, the method may begin where the relation management device 301 receive a request from the relation play-back device 302 to provide a subset of contents and the associated relation metadata 104. As one skilled in the art will appreciate, the method may run in parallel in one or plurality of relation management devices 301 and relation playback devices 302.

In step 401 the relation management device 301 receives a content 101 to be added to the content collection 200. The content 101 may be added by a user through the relation management device 301, through a Uniform Resource Locator associated with a process run on the relation management device 301, or through other manual means facilitated by a user through the relation playback device 302. In some embodiments, the content 101 is located and submitted through a web crawling or searching process that is able to locate the content 101, extract the information from the content 101, and based on the analyzed content 101 the relation management device 301 is able to determine a suitable content collection 200 to input the content 101 into. In some embodiments, the relation management device 301 using computer learning technology or artificial intelligence technology, wherein based on previous monitored behavior and the content 101 present in the relation collection 200, a process is able to locate additional content 101, that is relevant and related to the existing content 101 in content collection 200. In some embodiments, the system may automatically detect a relation and initiate a request to create a relation based on previously recorded behavior and gathered data. A program is able to automatically incorporate the content, build the relations 102, and update the relation collection 200. The process may be a form of, but not limited to, artificial intelligence, neural network, deep learning, reinforcement learning, Bayesian learning, or a combination thereof. In some embodiments, the automatic process may determine the relation type, weight score, and generate the request to create/adjust a relation.

In embodiments, where a content 101 is submitted to a content collection 200, the content 101 is analyzed to determine if the content 101 already exists in the content collection 200. In one embodiment, if it is determined that the content is similar to the preexisting content to a predetermined degree of similarity based on a plurality of factors, and these contents are merged into a single content. The factors may be based on various pieces of metadata associated with the content 101, and information included within the content 101. In some embodiments, where the contents 101 are not able to be combined, a relation 102 is automatically assigned to the two or more contents.

At step 402 the relation management device 301 receives a request to add a relation 102 to a relation collection 200, wherein two or more contents 101 are present. The request to add a relation 102 may come from a plurality of different events occurring, such as the additional of a new content to a relation collection 200 or the request to determine a new relation 102 in a relation collection 200 with a preexisting set of contents. A relation collection 200 exists wherein two or more contents are present and there may be preexisting relationships between these contents. In some embodiments, the relation collection 200 has no preexisting relationships between the contents. In some embodiments, when a content is added to a relation collection 200, which initiates the request to add at least one relation 102 between the preexisting contents and the newly added content. There may be instances where a content is incorporated into a relation collection 200 and have preexisting relations 102 already determined which are integrated into the relation collection 200 and the contents. The content(s) maybe added manually by a user, a program, or a system, or the content(s) may be added automatically through various computing systems and programs. In additional embodiments, when one or more contents are modified or updated, a request to add a relation 102 is sent. In further embodiments, a request may be submitted manually, at a predetermined time or interval, or based on various parameters and predetermined conditions.

In some embodiments, the relation creation request may be generated automatically by an adaptable algorithm that dynamically changes based on, but not limited to, the previously monitored behavior of the relation management device 301 and users, the content 101 information, and information in other contents 101 in content collection 200. The algorithm adaptation process may be a form of, but not limited to, artificial intelligence, neural network, deep learning, reinforcement learning, Bayesian learning, or a combination thereof.

In some embodiments, the content data/information may be modified, adjusted, or restructured to meet requirements of the preexisting contents in the relation collection 200. In some embodiments, this involves removing data or information which is not relevant to the relation collection 200.

At step 403, the relation management device 301 determines whether the received relation at step 402 already exists in the relation collection 200. In some embodiments, the relation management device 301 may search one or more relation collections 200, or various databases or storage locations which contain relevant information, contents, and previously created relations. For example, the relation management device 301 may look for relations 102 in the relation collection 200 where their source content, destination content, and relation 102 type are identical to those of the requested relation 102. If there is the relation 102, the relation 102 is determined to already exist, and the operation proceeds to step 404. If it is determined that the new relation 102 does not exist, the process continues to step 403. In some embodiments, the relation 102 needs to be identical to the preexisting relation 102 in the relation collection 200. In some embodiments, the relation 102 needs to exist between the same contents in the relation collection 200.

In some embodiments, the determination if a relation already exists may be an adaptable function that may dynamically change based on, but not limited to, the previously monitored the previous behavior of the relation management device 301 of the system and users, the content 101 information, and information in other contents 101 in content collection 200. The function adaptation process may be a form of, but not limited to, artificial intelligence, neural network, deep learning, reinforcement learning, Bayesian learning, or a combination thereof.

At step 404, the relation management device 301 incorporates the relation in the relation collection 200. Once the relation 102 is input into the relation collection 200, the relation 102 is given a default weight score. The default weight score may be provided manually by a user or may be calculated by the relation management device 301. The calculated default weight score may include various factors which adjust the default weight score. Examples of the various factors are, but not limited to, the quantity of interaction with the content, the number of relations created by a single user, the value of the weight score given by a user, or the like. In some embodiments, the default weight score is a predetermined score based on the relation collection 200 parameters. In some embodiments, the default weight score may be calculated by an automatic process.

In some embodiments, the weight score adjustment value calculation function may be an adaptable function that may dynamically change based on, but not limited to, the previously monitored the previous behavior of the relation management device 301, the system and the user, the content 101 information, and information in other contents 101 in content collection 200. The function adaptation process may be a form of, but not limited to, artificial intelligence, neural network, deep learning, reinforcement learning, Bayesian learning, or a combination thereof.

At step 405, the relation management device 301 adjusts the weight score of the relation based on the existence of the relation 102 in the relation collection 200. In some embodiments of the invention, the weight score adjustment may be done by a linear function, for example, by just adding a default weight score to the current weighted score of the relation 102. For example, if a relation 102 is assigned a default weight score of one (1) when the weight score is adjusted it is increased to two (2). In some embodiments, the adjustment is multiplied by the result of a function with a coefficient value. In other embodiments, the weight score adjustment may be calculated by a non-linear function given the default weight score. In some embodiments, a user's manual adjustment to the weight score is incorporated into the adjustment. A linear or non-linear weight update function may further use any information available in the relation collection 200 or user data to calculate the weight score of the relation 102. At this step the relation metadata 104 may be updated by adding the information in the request including, but not limited to, a comment, the user information who updates the relation 102, and the time of update. In some embodiments, the adjustment is determined by the input request and the specific parameters of the relation collection 200.

In some embodiments, the weight score adjustment or value calculation function may be an adaptable function that may dynamically change based on, but not limited to, the previously monitored the previous behavior of the relation management device 301 of the system and users, the content 101 information, and information in other contents 101 in content collection 200. The function adaptation process may be a form of, but not limited to, artificial intelligence, neural network, deep learning, reinforcement learning, Bayesian learning, or a combination thereof.

At step 406, the relation management device 301 aggregates the information in the relation collection 200 and stores the data. Alternatively, according to other embodiments, the aggregation occurs when the relation management device 301 is going to provide a subset of the relations 102 or contents to the relation playback device 302. Examples of information aggregation can be adding the count of related contents to each content or extracting the history of relations 102 that have been created for a specific content. Another example of the aggregation is calculating a rank score for each content. This rank score is used to sort or rank the contents in the relation collection 200. The rank score calculation may be based on including, but not limited to, the number of relations 102 to or from that content. A calculation of the weighted score of all the contents associated with the content. Another example of aggregation can be assigning a content category to each content based on its related contents and the content information. Yet another example of aggregation can be inferring more relations based, in part, on the user created relations. A more explicit example of this can be when content 101A has a relation 102 to content 101B with support relation-type and the relation has a relation 102 to content 101C with reject relation-type, a relation can be inferred between contents 101A and 101C with reject relation-type.

At step 407, an accessibility list is generated or modified if such exists for one or more users. This list may comprise references to the contents and/or relations in the relation collection 200 and provides a priority order for the relation management device 301 to provide the contents and relations 102 at step 408 and the relation playback device 302 to display the contents and the relations to user(s) at step 409. The accessibility list may serve as a recommendation list of contents and relations for users. The accessibility list may be reordered based on any information available in the relation collection 200 including the aggregated information done at step 405 and information about one or more users. For example, the content references in the list may be ordered by the rank score calculated at step 405 such that the contents with highest rank scores are accessed first. The order of the accessibility list may be based on variety of factors including, but not limited to, user's location, time, most viewed content categories, some user preference configurations, content recency, etc. The reordered list may be stored in various storage mediums and the reordering may be done before step 408 when the relation management device 301 is going to provide a subset of the contents and relations 102 to the user and/or at step 409 when the relation playback device 302 displays the contents and relations to the user.

At step 408, the relation management device 301 receives a request to provide a subset of contents and their relations in the relation collection 200 to the relation playback device 302. The request may include one or more content or relation identifiers, or it may include a search criterion to find a desired subset of contents and/or relations. For example, the request may contain a text pattern to get only the contents, relations, or aggregated relation-information whose data match with the given text pattern. The request may further comprise at least one criteria by which the accessibility list may get reordered. Examples of the criteria can be, but not limited to the number of the relations, the publication date of the relation, the weight score applied to the relation or the contents connected by the relation, and the like Yet in other embodiments, the relation management device 301 may be configured to generate the request automatically every time a relation metadata 104 is received at step 401 or based on specific events occurred in the relation management device 301 without the need for user interference.

At step 409, the relation management device 301 provides the subset of the contents and their relations in the relation collection 200 to a plurality of approved users. The matching contents and/or relations are prioritized based on the accessibility list generated, then are sent to the relation playback device 302 of the approved users. The relation information may also include the aggregated information.

At step 410, the relation playback device 302 displays the contents and their relations. The relation management device 101 may use the information received from the server response and show the list of relations in a variety of ways without departing from the spirit or scope of the invention. For example, the relation playback device 302 may list the contents and display the number of related contents to each content categorized by their relation type. The relation playback device 302 may also show the details of a content and the details of the relations to or from the content including, but not limited to, the users who has created the relations and/or updated the weight score of the relations, the comments on the relations, additional contents that have been added to the relations data, the time and the location identifier of the users who have created or updated the relations, etc.

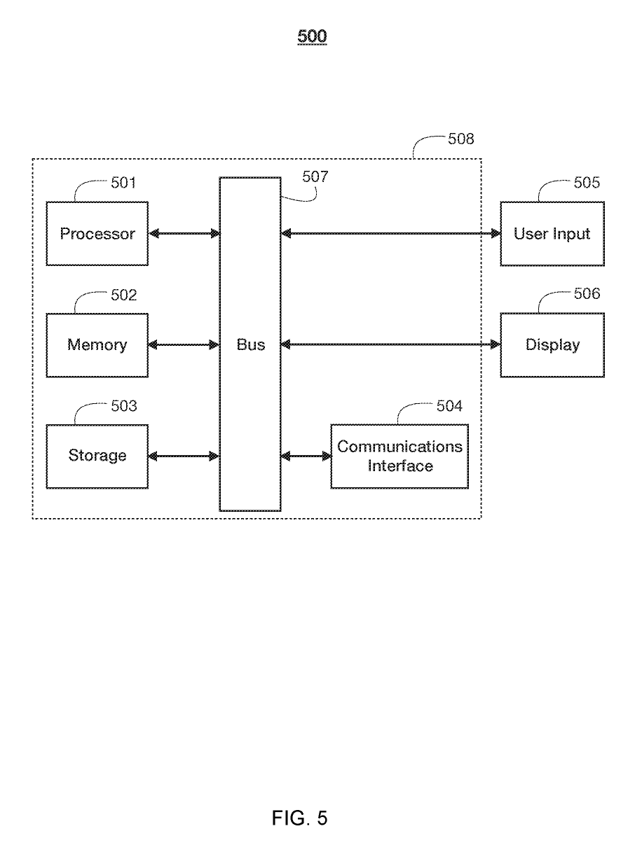

FIG. 5 is a block diagram of a computer system in accordance with an illustrative implementation. The computer system or computing device 500 can be used to implement relation management device 301 and relation playback device 302. The computing system or computing device 500 includes a bus 507 or other communication component for communicating information and a processor 501 or processing circuit coupled to the bus 507 for processing information. The computing system or computing device 500 can also include one or more processors 501 or processing circuits coupled to the bus 507 for processing information. The computing system or computing device 500 may also include main memory 502, such as a random-access memory (RAM) or other dynamic storage device, coupled to the bus 507 for storing information, and instructions to be executed by the processor 501. Main memory 502 can also be used for storing position information, temporary variables, or other intermediate information during execution of instructions by the processor 501. A storage 503, such as a solid-state device, magnetic disk or optical disk, is coupled to the bus 507 for persistently storing information and instructions.

The computing system or computing device 500 may be coupled via the bus 507 to a display 506, such as a liquid crystal display, or active matrix display, for displaying information to a user. A user input 505, such as a keyboard including alphanumeric and other keys, may be coupled to the bus 507 for communicating information and command selections to the processor 501. In another implementation, the user input 505 has a touch screen display 506 or a voice input with speech recognition capability. The user input 505 can include a cursor control, such as a mouse, a trackball, or cursor direction keys, for communicating direction information and command selections to the processor 501 and for controlling cursor movement on the display 506. In another implementation, the display 506 might be the outputs of wearable technologies such as VR movements or haptic outputs.

According to various implementations, the processes described herein can be implemented by the computing system or computing device 500 in response to the processor 501 executing an arrangement of instructions contained in main memory 502. Such instructions can be read into main memory 502 from another computer-readable medium, such as the storage 503. Execution of the arrangement of instructions contained in main memory 502 causes the computing system or computing device 500 to perform the illustrative processes described herein. One or more processors in a multi-processing arrangement may also be employed to execute the instructions contained in main memory 502. In alternative implementations, hard-wired circuitry may be used in place of or in combination with software instructions to effect illustrative implementations. Thus, implementations are not limited to any specific combination of hardware circuitry and software.

Although an example computing system has been described in FIG. 5, implementations of the subject matter and the functional operations described in this specification can be implemented in other types of digital or analog circuitry, or in computer software, firmware, or hardware, including the structures disclosed in this specification and their structural equivalents, or in combinations of one or more of them.

The subject matter described in this specification can be implemented as one or more computer programs, i.e., one or more modules of computer program instructions, encoded on one or more computer storage media for execution by, or to control the operation of, data processing apparatus. Alternatively, or in addition, the program instructions can be encoded on an artificially-generated propagated signal, e.g., a machine-generated electrical, optical, electromagnetic, or quantum, signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple, CDs, disks, or other storage devices). Accordingly, the computer storage medium can be both tangible and non-transitory. The computer storage medium can be ritualized and accessed indirectly via visualization software and/or hardware such as cloud computing and storage platforms.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, quantum computing systems and any one or more processors of any kind of digital or analog computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feed-back provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for resolving terminated transactions, the method comprising:
receiving, by one or more processors, a first content submitted to a content collection;
analyzing, by one or more processors, the first content in relation to at least one existing content within the content collection;
processing, by one or more processors, the relation between the first content and the at least one existing content and determining if a relationship exists between the contents;
creating, by one or more processor, a set of relation data between the new content and the at least one existing content, wherein it is determined that a relationship exists between the contents;
calculating, by one or more processors, a score value between the association of the first content and each of the at least one existing content which a set of relation data was created between the contents;
aggregating, by one or more processors, a data set of the at least one content and the relations between the at least one contents within the content collection;
adjusting, by one or more processors, accessibility of the aggregated data set based on the score value associated with each content and the content collection;
processing, by one or more processors, a request for a data subset of the data set, wherein the data subset is associated with a predetermined and adaptable set of parameters of the data set; and
formatting, by one or more processors, the requested data subset to a readable format.

2. The method of claim 1, wherein, the first content is received with the relation substantially simultaneously in the request and processed substantially simultaneously.

3. The method of claim 1, further comprising adjusting, by one or more processors, the score value with a modifier value.

4. The method of claim 3, wherein the modifier value is calculated using an adaptable function, wherein the adaptable function is a learning algorithm.

5. The method of claim 1, further comprising, generating, by one or more processors, a relation between at least two contents, wherein the generation of the relation is substantially automatic based on a set of stored data, wherein the set of stored data contained information related to previously created relations and received content.

6. The method of claim 1, wherein the generating of a relation between at least two contents is performed by a learning algorithm.

7. The method of claim 1, wherein the set of relation data includes a relation type identifier, a weight score, a function by which the relation weight score may get changed, the time of creation or update, information about the user(s) who create or update the relation, and user(s) comments.

8. The method of claim 1, further comprising, receiving, by one or more processors, at least one new content in the content collection.

9. The method of claim 8, further comprising, comparing, by one or more processors, the new content and the at least one preexisting content, and if it is determined that the new content is within a predetermined and adaptable threshold of similarity to one of the at least one preexisting content.

10. The method of claim 9, further comprising, merging, by one or more processors, the new content with each of the at least one preexisting content which surpassed the predetermined and adaptable threshold.

11. The method of claim 8, further comprising, assigning, by one or more processors, the new content and the at least one preexisting content a set of relation data substantially automatically if it is determined that the new content is within a predetermined and adaptable threshold of similarity to one of the at least one preexisting content.

12. A computer program product for resolving terminated transactions, the method comprising:
one or more computer readable storage media and program instruction stored on the one or more computer readable storage media, the program instructions comprising:
program instructions to receive relationship data between at least two contents within a content collection;
program instructions to process the relationship data between the at least two contents and determining if a relationship already exists based on the relationship data, wherein a relationship does not exist;
program instructions to create a relation between the at least two contents;
program instructions to calculate a score value between the at least two contents;
program instructions to aggregate a content collection data set;
program instructions to adjust accessibility of the aggregated content collection data set;
program instructions to process a request for a subset data set of the content collection data set; and
program instructions to provide the requested subset data set.

13. The computer program product of claim 12, further comprising; program instructions to display the requested data set.

14. The computer program product of claim 13 wherein a coefficient value to calculate the score value.

15. The computer program product of claim 14, wherein the coefficient value is calculated using a linear function.

16. A computer system for protecting a resource, the computer program product comprising:
one or more computer processors, one or more computer readable storage media, and program instructions stored on the one or more computer readable storage media for execution by, at least one of the one or more processors, the program instructions comprising:
program instructions to receive a first content submitted to a content collection;
program instructions to analyze, the first content in relation to at least one existing content within the content collection;
program instructions to process, the relation between the first content and the at least one existing content and determining if a relationship exists between the contents;
program instructions to create a set of relation data between the new content and the at least one existing content, wherein it is determined that a relationship exists between the contents;
program instructions to calculate a score value between the association of the first content and each of the at least one existing content which a set of relation data was created between the contents;
program instructions to aggregate a data set of the content collection data;
program instructions to adjust the accessibility of the aggregated content collection data set;
program instructions to process a request for a subset data set of the data set of the content collection; and
program instructions to format the requested subset data set and presenting in a readable format.

17. The computer system of claim 16, further comprising, merging, by one or more processors, the new content with at least one of

18. The computer system of claim 16, further comprising, program instructions to receive at least one new content in the content collection.

19. The computer system of claim 18, further comprising, program instructions to compare the new content and the at least one preexisting content, and if it is determined that the new content is within a predetermined and adaptable threshold of similarity to one of the at least one preexisting content.

20. The computer system of claim 19, further comprising, program instructions to merge the new content with each of the at least one preexisting content which surpassed the predetermined and adaptable threshold.
